(19) United States
(12) Patent Application Publication
(10) Pub. No.: US 2019/0087036 A1
(43) Pub. Date: Mar. 21, 2019

(54) PEN-INPUT SURFACE MATERIAL, POLARIZING PLATE, AND DISPLAY DEVICE

(71) Applicant: Sharp Kabushiki Kaisha, Sakai City (JP)

(72) Inventors: Masaomi KUWABARA, Sakai City (JP); Takayuki NATSUME, Sakai City (JP); Masaaki SAITOH, Sakai City (JP); Kenji FUJITA, Sakai City (JP); Shinichi MIYAZAKI, Sakai City (JP); Noriyuki HOSHIAI, Sakai City (JP)

(21) Appl. No.: 16/131,073

(22) Filed: Sep. 14, 2018

(30) Foreign Application Priority Data
Sep. 21, 2017 (JP) 2017-181129

(51) Int. Cl. G06F 3/044; G06F 3/0354; G02B 5/30

(52) U.S. Cl. CPC G06F 3/044; G02B 5/3025; G06F 3/03545

(57) ABSTRACT

A pen-input surface material has a surface on which an input is to be performed with a pen. The surface has ten-point average roughness (Rzjis) ranging from 0.1 μm to 6 μm inclusive, an average space between asperities (RSm) ranging from 30 μm to 500 μm inclusive, and skewness (Rsk) of zero or higher.

### CROSS REFERENCE TO RELATED APPLICATION

This application claims priority from Japanese Patent Application No. 2017-181129 filed on Sep. 21, 2017. The entire contents of the priority application are incorporated herein by reference.

### TECHNICAL FIELD

The technology described herein relates to a pen-input surface material, a polarizing plate, and a display device.

### BACKGROUND

There has been conventionally known an example of a surface material for a display on which an input can be performed with a pen as described in Japanese Unexamined Patent Application Publication No. H07-244552. The surface material for a pen-input computer tablet has a base material made of a transparent plastic film and an ionizing radiation curable resin layer formed on the surface of the base material. The ten-point average roughness (Rz) of the surface of the ionizing radiation curable resin layer is 0.5 to 5.0 μm and the average space (Sm) between asperities on the surface is 50 to 500 μm.

With the surface material for pen-input computer tablet described in Japanese Unexamined Patent Application Publication No. H07-244552, at the time of pen input, a user feels writing properties with an appropriate sense of resistance as if actually writing on a paper surface with a normal pen. However, according to the configuration described in Japanese Unexamined Patent Application Publication No. H07-244552, the surface of the surface material may be damaged by the pen input. If the surface material is damaged, the display is deteriorated in visibility and an outer appearance.

The technology described herein was made in view of the above circumstances. An object is to cause less damage on a surface.

### SUMMARY

A pen-input surface material of the technology described herein has a surface on which an input is to be performed with a pen. The pen-input surface material has ten-point average roughness (Rzjis) ranging from 0.1 μm to 6 μm inclusive, an average space between asperities (RSm) ranging from 30 μm to 500 μm inclusive, and skewness (Rsk) of zero or higher.

Numerous minute asperities are formed on the surface on which input is to be performed by a pen. The indexes for the surface roughness relating to the asperities include the ten-point average roughness (Rzjis), the average space between the asperities (RSm), and the skewness (Rsk). The ten-point average roughness (Rzjis) is an index for a vertical gap between the asperities on the surface. The average space between the asperities (RSm) is an index for the density of the asperities on the surface. The skewness (Rsk) is an index for the proportion between the concave portions and the convex portions included in the asperities on the surface. When an input is performed with a pen on the surface, the action of the pen acting on the asperities of the surface and the action of the asperities on the surface acting on the pen may be varied depending on the numeric values of the foregoing indexes. For example, if the ten-point average roughness (Rzjis) of the surface exceeds 6 μm, the vertical gap between the asperities on the surface is excessively large to cause a problem of excess wearing of the pen by the asperities. In addition, the surface having the asperities is not sufficiently flattened with shavings from the worn pen, and the surface is likely to be damaged. In contrast, if the ten-point average roughness (Rzjis) of the surface is below 0.1 μm, the vertical gap between the asperities on the surface is too small and the wearing of the pen by the asperities is insufficient. Accordingly, the surface having the asperities is not flattened sufficiently with shavings from the worn pen, and the surface is likely to be damaged. If the average space between the asperities (RSm) on the surface exceeds 500 μm, the arrangement density of the asperities on the surface is too low and the wearing of the pen by the asperities is insufficient. Accordingly, the surface having the asperities is not flattened sufficiently with shavings from the worn pen, and the surface is likely to be damaged. In contrast, if the average space between the asperities (RSm) on the surface is below 30 μm, the arrangement density of the asperities on the surface is too high. Accordingly, shavings from the pen enter the asperities and are hard to be removed. If the skewness (Rsk) has a negative value, the proportion of the convex portions of the asperities on the surface is higher than the proportion of the concave portions. Accordingly, the pen is contacted with the convex portions excessively so that the surface is likely to be damaged.

In contrast, if the ten-point average roughness (Rzjis) on the surface is 6 μm or less, the vertical gap between the asperities on the surface is less likely to be excessively large. Accordingly, the wearing of the pen by the asperities is within an acceptable range and the surface having the asperities is sufficiently flattened with shavings from the worn pen and the surface is less likely to be damaged. If the ten-point average roughness (Rzjis) on the surface is 0.1 μm or more, the vertical gap between the asperities on the surface is less likely to be excessively small. Accordingly, the pen is sufficiently worn by the asperities and the surface having the asperities is sufficiently flattened with shavings from the pen and the surface is less likely to be damaged. If the average space between the asperities (RSm) on the surface is 500 μm or less, the arrangement density of the asperities on the surface is less likely to be excessively low. Accordingly, the pen is sufficiently worn by the asperities and the surface having the asperities is sufficiently flattened with shavings from the pen and the surface is less likely to be damaged. If the average space between the asperities (RSm) on the surface is 30 μm or more, the arrangement density of the asperities on the surface is less likely to be excessively high. Accordingly, even if shavings from the pen enter the asperities, the shavings can be easily removed. If the skewness (Rsk) on the surface is zero or higher, namely, zero or a positive value, the proportion of the concave portions and that of the convex portions included in the asperities on the surface are equal, or the proportion of the concave portions is higher than the proportion of the convex portions. Accordingly, the pen is less likely to be contacted with the convex portions excessively and the surface is less likely to be damaged. Accordingly, when an input is performed with a pen on the surface, shavings of the pen enter the asperities on the surface and the surface having the asperities is flattened, and the surface is less likely to be damaged by rubbing of the pen. In addition, the shavings can be easily removed from the asperities.

According to the technology described herein, a surface is less likely to be damaged.

### BRIEF DESCRIPTION OF THE DRAWINGS

FIG. 1 is a schematic cross-sectional view of a liquid crystal display device according to an embodiment of the technology described herein.

FIG. 2 is a planar view of a liquid crystal panel included in the liquid crystal display device.

FIG. 3 is a cross-sectional view of a polarizing plate attached to the front side of the liquid crystal panel.

FIG. 4 is a cross-sectional view of concave portions and convex portions on the surface of a pen-input surface material.

FIG. 5 is a table showing results of a comparative experiment.

### DETAILED DESCRIPTION

### Embodiment

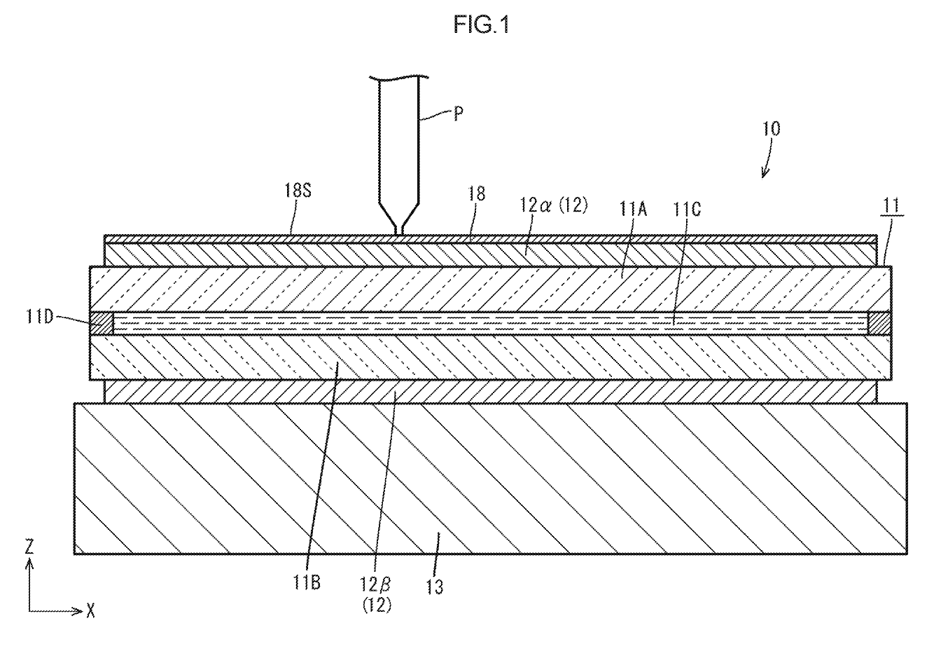

An embodiment of the technology described herein will be described with reference to FIGS. 1 to 5. In the present embodiment, a liquid crystal display device 10 having a display function and a touch panel function (position-input function) (display device or display device with a position inputting function) is taken as an example. X-axis, Y-axis and Z-axis may be present in the drawings and each of the axial directions represents a direction represented in each drawing. The upward and downward directions are determined with reference to FIGS. 1, 3, and 4 such that an upper side and a lower side in the drawings match a front side and a back side, respectively.

As illustrated in FIG. 1, the liquid crystal display device 10 has a transmissive liquid crystal panel (display panel) 11 that can display images, a pair of polarizing plates 12 that is attached to the front and back plate surfaces of the liquid crystal panel 11, and a backlight device (illumination device) 13 that is arranged to overlap the liquid crystal panel 11 on the back side thereof and supplies light rays to the liquid crystal panel 11 for display. First, the backlight device 13 will be briefly described. Although not illustrated, the backlight device 13 at least includes a light source (for example, LEDs or organic ELs), an optical member that allows light from the light source to pass through while exerting optical action on the light, and a reflection sheet that reflects light toward the liquid crystal panel 11 side.

The liquid crystal panel 11 will be described. As illustrated in FIG. 1, the liquid crystal panel 11 has a pair of substrates 11A and 11B, a liquid crystal layer (medium layer) 11C that is in an internal space between the substrates 11A and 11B and contains liquid crystal molecules as a substance varying in optical characteristics according to application of electric field, and a seal portion 11D that is between the substrates 11A and 11B and surrounds and seals the liquid crystal layer 11C. One of the pair of substrates 11A and 11B on the front (a front-surface side) is the CF substrate (counter substrate) 11A and another one on the back (a back-surface side) is the array substrate (active matrix substrate, TFT substrate) 11B. Each of the CF substrate 11A and the array substrate 11B is formed by laminating various films on the inner surface of a glass substrate.

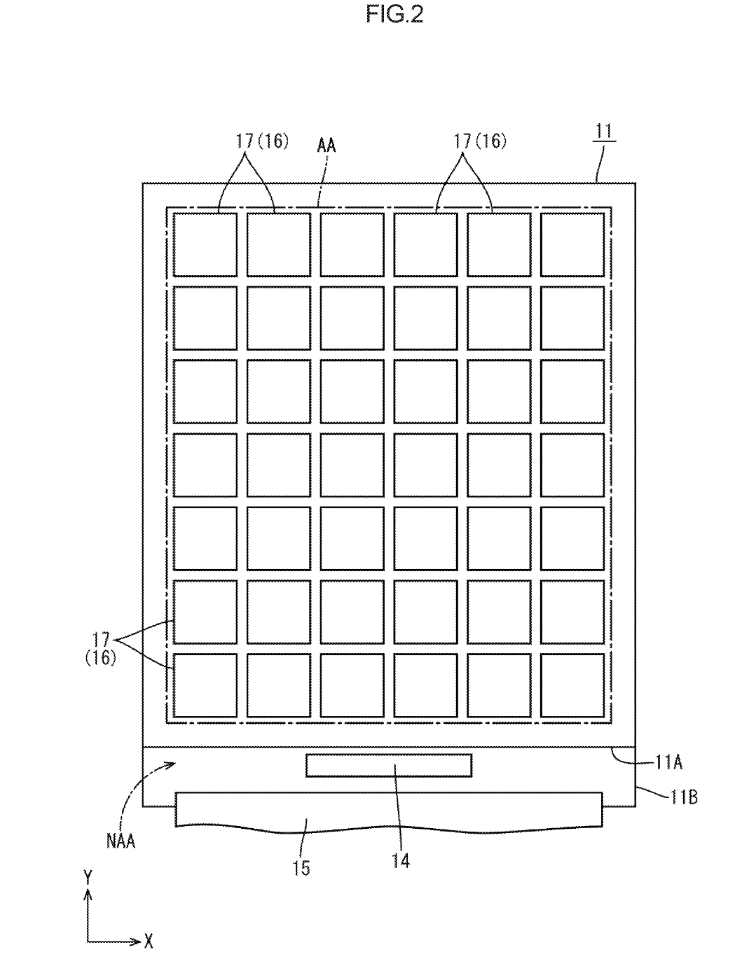

As illustrated in FIG. 2, the liquid crystal panel 11 has a display region (surrounded by a one-dot chain line in FIG. 2) AA where images are to be displayed in the central of the screen and has a non-display region NAA where no images are to be displayed in a frame-like outer peripheral portion surrounding the display region AA in the screen. The array substrate 11B included in the liquid crystal panel 11 is larger in size than the CF substrate 11A. A portion of the array substrate 11B protrudes sideways with respect to the CF substrate 11A. The protruding portion (non-display region NAA) has a driver (panel drive component) 14 and a flexible circuit board (signal transmission member) 15 as components for supplying various signals relating to a display function and a touch panel function. The driver 14 includes an LSI chip with a drive circuit therein and is implemented on the array substrate 11B in a chip-on-glass (COG) manner to process various signals to be transmitted by the flexible circuit board 15. The flexible circuit board 15 has wiring including a large number of lines on an insulating and flexible base material. The flexible circuit board 15 is connected to the array substrate 11B and a control substrate (signal supply source), which is not illustrated, in the liquid crystal panel 11 to transmit the various signals output from the control substrate to the liquid crystal panel 11.

Next, an internal structure of the liquid crystal panel 11 will be briefly described, although various structural components of the internal structure are not illustrated in the drawings. On the inner-surface side of the array substrate 11B in the display region AA, a large numbers of thin film transistors (TFT), that are switching components, and pixel electrodes are arranged in a matrix (row-and-column). Gate lines and source liens are arranged in a grid pattern around the TFTs and the pixel electrodes to surround them. Signals related to images are transmitted to the gate lines and the source lines. The pixel electrodes arranged in regions surrounded by the gate lines and the source lines are formed of a transparent electrode material. On the inner-surface side of the array substrate 11B in the display region AA, as illustrated in FIG. 2, a common electrode extends over substantially the entire display region AA and covers all the pixel electrodes with an insulating film that is between the common electrode and the pixel electrodes. The common electrode is supplied with a substantially constant reference potential and potential difference may be generated between the common electrode and the pixel electrode according to a potential charged in the pixel electrode. The electric field generated based on the difference in potential between the common electrode and the pixel electrodes includes a fringe electric field (oblique electric field) containing a component along the plate surface of the array substrate 11B and a component along a normal direction to the plate surface of the array substrate 11B. Therefore, a driving type of the liquid crystal panel 11 is a fringe field switching (FFS) mode in which alignment of the liquid crystal molecules in the liquid crystal layer 11C is controlled by using the fringe electric field. On the other hand, a large number of color filters are provided on the inner surface of the CF substrate 11A at positions corresponding to the pixel electrodes such that the colors of R, G, and B are alternately arranged. A light blocking portion (black matrix) is provided on the inner surface of the CF substrate 11A to separate the adjacent color filters to prevent color mixture. Alignment films are formed on the respective inner surfaces of the substrates 11A and 11B for aligning the liquid crystal molecules in the liquid crystal layer 11C.

The liquid crystal panel 11 according to the present embodiment has both a display function of displaying images and a touch panel function (position input function) of detecting a position of input (input position) performed by a user with a touch pen (pen) P based on the displayed images. The liquid crystal panel 11 integrally includes (as an in-cell structure) a touch panel pattern 16 for performing the touch panel function. The touch panel pattern 16 is a projected capacitive type and its detection method is a self-capacitance method. Of the pair of substrates 11A and 11B, the touch panel pattern 16 is provided on the array substrate 11B side as illustrated in FIG. 2. The touch panel pattern 16 includes a plurality of touch electrodes (position detection electrodes) 17 disposed in a matrix within the plate surface area of the array substrate 11B. The touch electrodes 17 are included in the common electrode provided on the array substrate 11B. The common electrode is divided in a substantial grid pattern in a planar view to form the touch electrodes 17 that are electrically independent of each other. The touch electrodes 17 are arranged in the display region AA. Therefore, the display region AA in the liquid crystal panel 11 substantially matches a touch region where an input position is detectable (position input region), and the non-display region NAA substantially matches a non-touch region where an input position is undetectable (non-position input region). When the user brings the touch pen P (see FIG. 1) close to the surface (display surface) of the liquid crystal panel 11 to input positions based on the image in the display region AA of the liquid crystal panel 11, capacitance is formed between the touch pen P and the touch electrodes 17. Accordingly, the capacitance detected by the touch electrodes 17 near the touch pen P changes according to the approach of the touch pen P and the capacitance is different from that in the touch electrodes 17 far from the touch pen P. Accordingly, the input position can be detected based on the capacitance change. Although not illustrated, the array substrate 11B has a touch line (position detection line) connected to each of the touch electrodes 17. The touch line is supplied with a reference potential signal relating to the display function and a touch signal (position detection signal) relating to the touch function at different timings. While the reference potential signal is supplied to the touch line, the touch electrode 17 acts as the common electrode at a reference potential. While the touch signal is supplied to the touch line, the touch electrode 17 detects the input position as described above. FIG. 2 schematically illustrates the arrangement of the touch electrodes 17. The specific number and arrangement of the touch electrodes 17 may be changed as appropriate differently from those illustrated in the drawing.

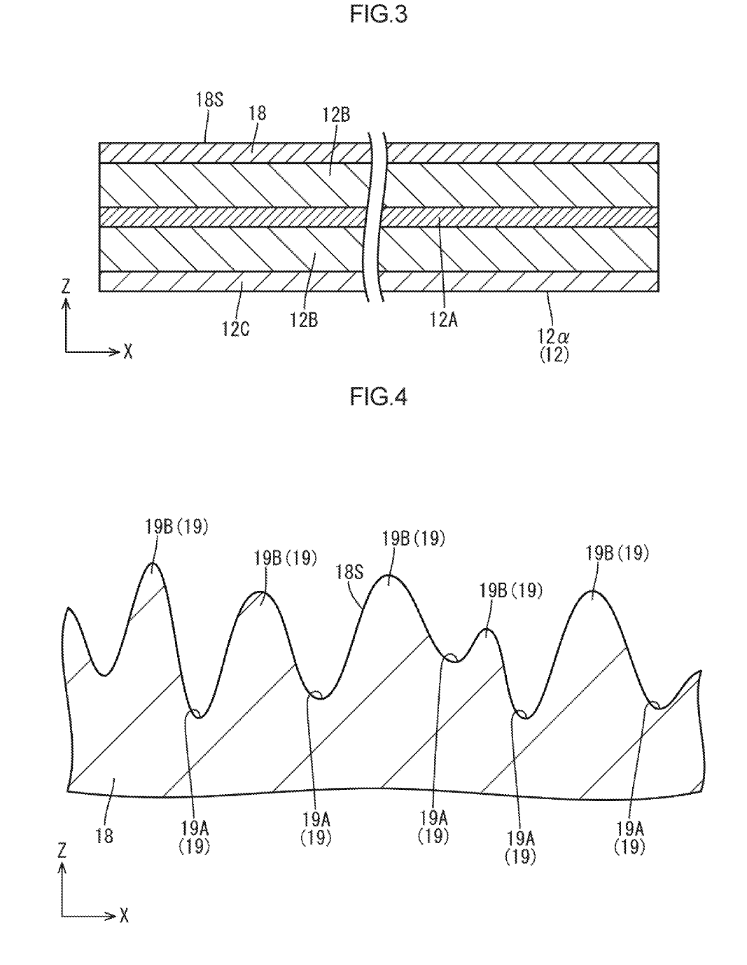

Next, the polarizing plate 12 will be described. The polarizing plate 12 is provided in a film form with a surface thereof along the plate surface of the liquid crystal panel 11. The polarizing plate 12 includes a first polarizing plate 12α that is arranged on the front side of the liquid crystal panel 11 and attached to the outer surface of the CF substrate 11A and a second polarizing plate 12β that is arranged on the back side of the liquid crystal panel 11 and attached to the outer surface of the array substrate 11B. Hereinafter, the common structure of the polarizing plates 12α and 12β will be described. FIG. 3 is a cross-sectional view of the first polarizing plate 12α and most of the structure is common with that of the second polarizing plate 12β. As illustrated in FIG. 3, each of the polarizing plates 12α and 12β at least includes a polarizer 12A that selectively transmits light in a specific vibration direction, a pair of base bodies 12B sandwiching the polarizer 12A therebetween, and a fixation layer 12C that is fixed to the outer surface of the liquid crystal panel 11. The polarizer 12A is formed by mixing an absorber such as iodine or dichromatic dye into a high polymer resin film such as polyvinyl alcohol (PVA) film and stretching in one direction to orient the absorber. The polarizer 12A formed by uniaxial stretching as described above has a transmission axis (polarization axis) and an absorption axis orthogonal to the transmission axis to convert circularly polarized light into linearly polarized light. The pair of base bodies 12B is formed of a triacetylcellulose (TAC) film that is excellent in light transmission and is substantially transparent. The fixation layer 12C is formed of an adhesive excellent in light transmission and substantially transparent, which is applied to the surface of either of the base bodies 12B opposite to the polarizer 12A side. The specific configuration of the polarizing plates 12 is not limited to the foregoing one, but can be changed as appropriate such as adding a retardation film, for example. The polarizing plates 12 having such a configuration are attached to the front and back outer surfaces of the liquid crystal panel 11, respectively. The pair of polarizing plates 12 is arranged such that their transmission axes (absorption axes) are orthogonal to each other, namely, is in a crossed nicols arrangement. According to the crossed nicols arrangement, the liquid crystal panel 11 is in normally black mode in which the liquid crystal panel 11 displays black with minimum transmittance at the de-energized time (when no voltage is applied to the pixel electrodes).

Of the pair of polarizing plates 12, the first polarizing plate 12α has a pen-input surface material 18 with a surface 18S on which an input is performed with the touch pen P as illustrated in FIG. 3. The pen-input surface material 18 is provided on a surface (application surface) of the front side base body 12B of the first polarizing plate 12α (opposite to the fixation layer 12C side base body). The pen-input surface material 18 is provided on the surface of the front side base body 12B opposite to the polarizer 12A side. The surface 18S of the pen-input surface material 18 is a contact surface with which the tip of the touch pen P is to be contacted directly. The pen-input surface material 18 is formed by dispersing and blending a filler (particles) in a base material of a synthetic resin. Each of the base material and the filler is formed of a material excellent in light transmission and substantially transparent. Examples of the material for the base material include pentaerythritol triacrylate as an ultraviolet curable resin (photocurable resin). The material for the filler is an organic material or an inorganic material. Examples of organic material for the filler include a styrene-acrylic resin, an acrylic resin, and a styrene resin. One or more of them may be used. The filler using an organic material will be referred to as an “organic filler”. Examples of inorganic material for the filler include silica (SiO₂) and others. The filler using an inorganic material will be referred to as an “inorganic filler”.

A method of manufacturing the pen-input surface material 18 will be described. First, a photopolymerization initiator, a thickener, a leveling agent, and a solvent are blended at a predetermined ratio into the base material and the filler described above, and the mixture is stirred for a predetermined time (for example, one hour or more) to obtain a coating material as a raw material (coating material production step). Examples of the photopolymerization initiator include Irgacure (registered trademark) 184 and Irgacure (registered trademark) TPO produced by BASF Japan Ltd. Examples of the thickener include a cellulose-based thickener. Examples of the leveling agent include a fluorine-based leveling agent. Examples of the solvent include toluene. The coating material obtained in the coating material production step described above is put on the application surface of the front-side base body 12B of the first polarizing plate 12α and spread at a predetermined uniform thickness (8 μm to 20 μm) by using an applicator or the like (application step). After that, the base body 12B coated with the coating material is dried once for a predetermined time (for example, 30 seconds) under an ordinary temperature and calm environment, and then is heated in an all-exhaust-type oven at a predetermined temperature (for example, about 100° C.) for a predetermined time (for example, one minute) to vaporize and remove the solvent from the coating material (drying step). The dried coating material dried in the drying step is irradiated with an ultraviolet ray to cure the coating material (curing step). In the curing step, the ultraviolet ray is emitted by a high-pressure mercury lamp, for example, and the coating material is irradiated with the ultraviolet rays at a predetermined peak illumination (100 mW/cm²) until a predetermined integrated irradiation dose (400 mJ/cm²) is reached. The ultraviolet ray has a wavelength of about 365 nm, for example, and the irradiation thereof is performed under a nitrogen environment. Accordingly, the pen-input surface material 18 having a predetermined thickness (4 μm to 10 μm) is integrally provided on the outer surface side of the first polarizing plate 12α.

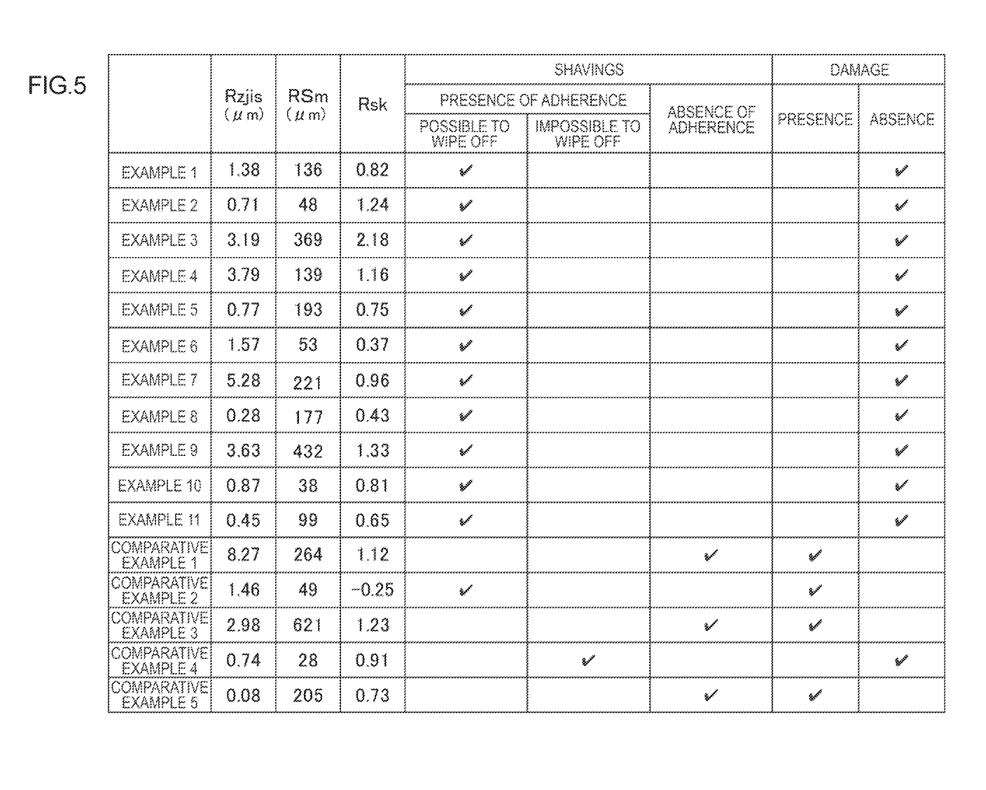

The pen-input surface material 18 according to the present embodiment has numerous minute asperities 19 on the surface 18S as illustrated in FIG. 4. The surface roughness with the asperities 19 is as described below. The pen-input surface material 18 is configured such that the ten-point average roughness (Rzjis) of the surface 18S is within a range of 0.1 μm to 6 μm inclusive, the average space between the asperities (RSm) on the surface 18S is within a range of 30 μm to 500 μm inclusive, and the skewness (Rsk) of the surface 18S is zero or higher. The pen-input surface material 18 is preferably configured such that the ten-point average roughness (Rzjis) of the surface 18S is within a range of 0.3 μm to 4 μm inclusive and the average space between the asperities 19 (RSm) on the surface 18S is within a range of 40 μm to 400 μm inclusive. The pen-input surface material 18 is more preferably configured such that the ten-point average roughness (Rzjis) of the surface 18S is within a range of 0.5 μm to 2 μm inclusive and the average space between the asperities 19 (RSm) on the surface 18S is within a range of 50 μm to 300 μm inclusive. The asperities 19 include concave portions 19A and convex portions 19B. FIG. 4 illustrates an example of them. The ten-point average roughness (Rzjis) is an index for the vertical gap between the asperities 19 on the surface 18S, which indicates the sum of an average of the maximum to fifth largest heights of the convex portions 19B and an average of the maximum to fifth largest depth of the concave portions 19A. The average space between the asperities 19 (RSm) is an index for the density of the asperities 19 on the surface 18S, which indicates an average value of spaces between the adjacent concave portions 19A and convex portions 19B. The skewness (Rsk) is an index for the proportion of the concave portions 19A and the convex portions 19B included in the asperities 19 on the surface 18S, namely, an index for the symmetry of height distribution of the asperities 19. The touch pen P for use in performing an input on the pen-input surface material 18 is made of a rubber or a synthetic resin (for example, polyacetal). The touch pen P may be worn and generate shavings by the action of the asperities 19 at the time of input depending on the numerical values of the indexes for the surface roughness relating to the asperities 19 on the surface 18S of the pen-input surface material 18. In contrast, the surface 18S of the pen-input surface material 18 may be damaged by the action of the touch pen P at the time of input. In addition, the ease of removing the shavings of the touch pen P from the asperities 19 (ease of wiping) may vary depending on the numerical values of the indexes for the surface roughness relating to the asperities 19.

For example, if the ten-point average roughness (Rzjis) of the surface 18S exceeds 6 μm, the vertical gap between the asperities 19 on the surface 18S is excessively large to cause a problem of excess wearing of the touch pen P by the asperities 19. In addition, the surface having the asperities 19 is not flattened sufficiently with the shavings from the worn touch pen P and the surface 18S is likely to be damaged. In contrast, if the ten-point average roughness (Rzjis) of the surface 18S is below 0.1 μm, the vertical gap between the asperities 19 on the surface 18S is too small and the wearing of the touch pen P by the asperities 19 is insufficient. Accordingly, the surface having the asperities 19 is not flattened with the shavings sufficiently and the surface 18S is likely to be damaged. If the average space between the asperities 19 (RSm) on the surface 18S exceeds 500 μm, the asperities 19 on the surface 18S are spaced too far from each other and the wearing of the touch pen P by the asperities 19 is insufficient. Accordingly, the surface having the asperities 19 is not flattened with the shavings sufficiently and the surface 18S is likely to be damaged. In contrast, if the average space between the asperities 19 (RSm) on the surface 18S is below 30 μm, the asperities 19 on the surface 18S are too close to each other. Accordingly, the shavings of the touch pen P enter the asperities 19 and are hard to be removed. If the skewness (Rsk) has a negative value, the proportion of the convex portions 19B is higher than the proportion of the concave portions 19A among the asperities 19 on the surface 18S. Accordingly, the touch pen P is contacted with the convex portions 19B excessively so that the surface 18S is likely to be damaged.

In contrast, according to the present embodiment, the ten-point average roughness (Rzjis) of the surface 18S is 6 μm or less and the vertical gap between the asperities 19 on the surface 18S is less likely to be excessively large. Accordingly, the wearing of the touch pen P by the asperities 19 is within an acceptable range and the surface having the asperities 19 is flattened with the shavings of the worn touch pen P sufficiently and the surface 18S is less likely to be damaged. Preferably, if the ten-point average roughness (Rzjis) on the surface 18S is 4 μm or less, the vertical gap between the asperities 19 on the surface 18S is preferable and the wearing of the touch pen P by the asperities 19 is appropriate. The surface having the asperities 19 is properly flattened with the shavings from the worn touch pen P and the surface 18S is further less likely to be damaged. More preferably, if the ten-point average roughness (Rzjis) on the surface 18S is 2 μm or less, the vertical gap between the asperities 19 on the surface 18S is more preferable. Accordingly, the wearing of the touch pen P by the asperities 19 is more appropriate and the surface having the asperities 19 is more properly flattened with the shavings from the worn touch pen P and the surface 18S is further less likely to be damaged. On the other hand, if the ten-point average roughness (Rzjis) on the surface 18S is 0.1 μm or more, the vertical gap between the asperities 19 on the surface 18S is not excessively small. Accordingly, the touch pen P is worn effectively by the asperities 19 and the surface having the asperities 19 is sufficiently flattened with the shavings from the touch pen P, and the surface 18S is less likely to be damaged. Preferably, if the ten-point average roughness (Rzjis) on the surface 18S is 0.3 μm or more, the vertical gap between the asperities 19 on the surface 18S is sufficiently ensured. Accordingly, the touch pen P is properly worn by the asperities 19 and the surface having the asperities 19 is properly flattened with the shavings from the touch pen P, and the surface 18S is further less likely to be damaged. More preferably, if the ten-point average roughness (Rzjis) on the surface 18S is 0.5 μm or more, the vertical gap between the asperities 19 on the surface 18S is more sufficiently ensured. Accordingly, the touch pen P is more properly worn by the asperities 19 and the surface having the asperities 19 is more properly flattened with the shavings, and the surface 18S is further less likely to be damaged.

If the average space between the asperities 19 (RSm) on the surface 18S is 500 μm or less, the asperities 19 on the surface 18S are less likely to be excessively far from each other. Accordingly, the touch pen P is sufficiently worn by the asperities 19 and the surface having the asperities 19 is flattened with the shavings sufficiently and the surface 18S is less likely to be damaged. Preferably, if the average space between the asperities 19 (RSm) on the surface 18S is 400 μm or less, the asperities 19 are properly close to each other on the surface 18S. Accordingly, the touch pen P is sufficiently worn by the asperities 19 and the surface having the asperities 19 is flattened with the shavings sufficiently and the surface 18S is less likely to be damaged. More preferably, if the average space between the asperities 19 (RSm) on the surface 18S is 300 μm or less, the asperities 19 are more properly close to each other on the surface 18S. Accordingly, the touch pen P is more favorably worn by the asperities 19 and the surface having the asperities 19 is more favorably flattened with the shavings, and the surface 18S is further less likely to be damaged. On the other hand, if the average space between the asperities 19 (RSm) on the surface 18S is 30 μm or more, the asperities 19 are less likely to be too close on the surface 18S. Accordingly, even if the shavings from the touch pen P enter the asperities 19, the shavings can be easily removed. Preferably, if the average space between the asperities 19 (RSm) on the surface 18S is 40 μm or more, the asperities 19 are properly away from each other on the surface 18S. Accordingly, even if the shavings from the touch pen P enter the asperities 19, the shavings can be easily removed. More preferably, if the average space between the asperities 19 (RSm) on the surface 18S is 50 μm or more, the asperities 19 are more favorably away from each other on the surface 18S. Accordingly, even if the shavings from the touch pen P enter the asperities 19, the shavings can be more easily removed.

Further, if the skewness (Rsk) of the surface 18S is zero or higher, namely, zero or a positive value, the proportion of the concave portions 19A and that of the convex portions 19B among the asperities 19 on the surface 18S are equal, or the proportion of the concave portions 19A is higher than the proportion of the convex portions 19B. Accordingly, the touch pen P is less likely to be contacted with the convex portions 19B excessively and the surface 18S is less likely to be damaged. Accordingly, when an input is performed with the touch pen P on the surface 18S, shavings from the touch pen P enter the asperities 19 on the surface 18S and the surface having the asperities 19 is flattened, and the surface 18S is less likely to be damaged by rubbing by the touch pen P. In addition, the shavings can be easily removed from the asperities 19.

Comparative experiments were carried out as described below to find how the action on the surface 18S of the pen-input surface material 18 varies according to the changes in the numerical values of the indexes for surface roughness relating to the asperities 19 on the surface 18S. In the comparative experiments, the pen-input surface materials 18 were produced in Examples 1 to 11 and Comparative Examples 1 to 5 and each of the numerical values of the indexes relating to the surface roughness of the surface 18S was measured. In addition, a rubbing test was performed by rubbing the surfaces 18S of the pen-input surface materials 18 in Examples 1 to 11 and Comparative Examples 1 to 5 with the touch pen P to determine whether shavings from the touch pen P adhere to the surfaces 18S, whether it is possible to wipe off the adhering shavings, and whether the surface 18S is damaged. The experimental results are as shown in FIG. 5. The indexes relating to surface roughness were measured in conformity with JIS B 0601: 2013, using the step meter “Surfcorder ET 4000A” produced by Kosaka Laboratory Ltd., under the conditions that the estimation length was 8 mm, the axial magnification was 20000, the linear magnification was 200, the cutoff value was 0.8 mm, and the feed speed was 0.05 mm/sec. The rubbing test with the touch pen P was performed with a writing endurance tester produced by Touch Panel Laboratories Co., Ltd. under the conditions that the material of the touch pen P was polyacetal, the radial diameter of the tip of the touch pen P was 0.8 mm, the rubbing load was 450 g, the moving speed was 210 mm/sec, the moving width was 35 mm, and the number of moving times was 5000 reciprocations. After the rubbing test, the presence or absence of damages on the surface 18S was checked and the presence or absence of adherence of shavings from the touch pen P was checked with the eyes and a microscope. If the adherence of shavings was observed, the shavings were wiped off by moving a dry cloth along a direction orthogonal to the moving direction of the touch pen P. After the wiping, the presence or absence of the damages and the presence or absence of the shavings on the surface 18S were checked with the eyes and the microscope.

In each of Examples 1 to 11 and Comparative Examples 1 to 5, pentaerythritol triacrylate was used as a material for the base material, 1 parts by mass of a cellulose-based thickener was used as a thickener, 0.05 parts by mass of a fluorine-based leveling agent was used as a leveling agent, and 50 parts by mass of toluene was used as a solvent. In Example 1, with relation to the surface roughness of the surface 18S, the ten-point average roughness (Rzjis) is 1.38 μm, the average space between the asperities 19 (RSm) is 136 μm, the skewness (Rsk) is 0.82, and the average thickness is 6 μm (12 μm before drying). Used in Example 1 are 43.2 parts by mass of a base material, 2.3 parts by mass of Irgacure (registered trademark) 184 as a photopolymerization initiator, and 3.5 parts by mass of a styrene-acrylic filler as an organic filler with an average particle diameter of 3.5 μm and a refractive index of 1.565. In Example 2, with relation to the surface roughness of the surface 18S, the ten-point average roughness (Rzjis) is 0.71 μm, the average space between the asperities 19 (RSm) is 48 μm, the skewness (Rsk) is 1.24, and the average thickness is 5 μm (10 μm before drying). Used in Example 2 are 41.8 parts by mass of a base material, 2.2 parts by mass of Irgacure (registered trademark) 184 as a photopolymerization initiator, and 2.5 parts by mass of an acrylic filler as an organic filler with an average particle diameter of 1.6 μm and a refractive index of 1.495, and 2.5 parts by mass of a styrene-acrylic filler as an organic filler with an average particle diameter of 1.4 μm and a refractive index of 1.545.

In Example 3, with relation to the surface roughness of the surface 18S, the ten-point average roughness (Rzjis) is 3.19 μm, the average space between the asperities 19 (RSm) is 369 μm, the skewness (Rsk) is 2.18, and the average thickness is 5 μm (10 μm before drying). Used in Example 3 are 44.1 parts by mass of a base material, 2.3 parts by mass of Irgacure (registered trademark) 184 as a photopolymerization initiator, and 2.5 parts by mass of an amorphous silica filler as an inorganic filler with an average particle diameter of 4 μm. In Example 4, with relation to the surface roughness of the surface 18S, the ten-point average roughness (Rzjis) is 3.79 μm, the average space between the asperities 19 (RSm) is 139 μm, the skewness (Rsk) is 1.16, and the average thickness is 4 μm (8 μm before drying). Used in Example 4 are 42.7 parts by mass of a base material, 2.2 parts by mass of Irgacure (registered trademark) 184 as a photopolymerization initiator, and 4 parts by mass of an amorphous silica filler as an inorganic filler with an average particle diameter of 4 μm. In Example 5, with relation to the surface roughness of the surface 18S, the ten-point average roughness (Rzjis) is 0.77 μm, the average space between the asperities 19 (RSm) is 193 μm, the skewness (Rsk) is 0.75, and the average thickness is 8 μm (16 μm before drying). Used in Example 5 are 43.2 parts by mass of a base material, 2.3 parts by mass of Irgacure (registered trademark) 184 as a photopolymerization initiator, and 2 parts by mass of an acrylic filler as an organic filler with an average particle diameter of 5.4 μm and a refractive index of 1.495, and 1.5 parts by mass of a styrene filler as an organic filler with an average particle diameter of 3.4 μm and a refractive index of 1.595. In Example 6, with relation to the surface roughness of the surface 18S, the ten-point average roughness (Rzjis) is 1.57 μm, the average space between the asperities 19 (RSm) is 53 μm, the skewness (Rsk) is 0.37, and the average thickness is 6 μm (12 μm before drying). Used in Example 6 are 42.2 parts by mass of a base material, 2.2 parts by mass of Irgacure (registered trademark) 184 as a photopolymerization initiator, and 1 part by mass of an acrylic filler as an organic filler with an average particle diameter of 5 μm and a refractive index of 1.495, and 3.5 parts by mass of an acrylic filler as an organic filler with an average particle diameter of 1.4 μm and a refractive index of 1.495.

In Example 7, with relation to the surface roughness of the surface 18S, the ten-point average roughness (Rzjis) is 5.28 μm, the average space between the asperities 19 (RSm) is 221 μm, the skewness (Rsk) is 0.96, and the average thickness is 4 μm (8 μm before drying). Used in Example 7 are 42.7 parts by mass of a base material, 2.2 parts by mass of Irgacure (registered trademark) 184 as a photopolymerization initiator, and 4 parts by mass of an amorphous silica filler as an inorganic filler with an average particle diameter of 5 μm. In Example 8, with relation to the surface roughness of the surface 18S, the ten-point average roughness (Rzjis) is 0.28 μm, the average space between the asperities 19 (RSm) is 177 μm, the skewness (Rsk) is 0.43, and the average thickness is 10 μm (20 μm before drying). Used in Example 8 are 43.2 parts by mass of a base material, 2.3 parts by mass of Irgacure (registered trademark) 184 as a photopolymerization initiator, and 3.5 parts by mass of a styrene-acrylic filler as an organic filler with an average particle diameter of 6 μm and a refractive index of 1.525. In Example 9, with relation to the surface roughness of the surface 18S, the ten-point average roughness (Rzjis) is 3.63 μm, the average space between the asperities 19 (RSm) is 432 μm, the skewness (Rsk) is 1.33, and the average thickness is 5 μm (10 μm before drying). Used in Example 9 are 44.6 parts by mass of a base material, 2.3 parts by mass of Irgacure (registered trademark) 184 as a photopolymerization initiator, and 2 parts by mass of an amorphous silica filler as an inorganic filler with an average particle diameter of 5 μm. In Example 10, with relation to the surface roughness of the surface 18S, the ten-point average roughness (Rzjis) is 0.87 μm, the average space between the asperities 19 (RSm) is 38 μm, the skewness (Rsk) is 0.81, and the average thickness is 5 μm (10 μm before drying). Used in Example 10 are 40.8 parts by mass of a base material, 2.1 parts by mass of Irgacure (registered trademark) 184 as a photopolymerization initiator, and 3 parts by mass of an acrylic filler as an organic filler with an average particle diameter of 1.6 μm and a refractive index of 1.495, and 3 parts by mass of a styrene-acrylic filler as an organic filler with an average particle diameter of 1.4 μm and a refractive index of 1.545. In Example 11, with relation to the surface roughness of the surface 18S, the ten-point average roughness (Rzjis) is 0.45 μm, the average space between the asperities 19 (RSm) is 99 μm, the skewness (Rsk) is 0.65, and the average thickness is 9 μm (18 μm before drying). Used in Example 11 are 43.2 parts by mass of a base material, 2.3 parts by mass of Irgacure (registered trademark) 184 as a photopolymerization initiator, and 3.5 parts by mass of a styrene-acrylic filler as an organic filler with an average particle diameter of 6 μm and a refractive index of 1.525.

In Comparative Example 1, with relation to the surface roughness of the surface 18S, the ten-point average roughness (Rzjis) is 8.27 μm, the average space between the asperities 19 (RSm) is 264 μm, the skewness (Rsk) is 1.12, and the average thickness is 6 μm (12 μm before drying). Used Comparative Example 1 are 45.1 parts by mass of a base material, 2.4 parts by mass of Irgacure (registered trademark) 184 as a photopolymerization initiator, and 1.5 parts by mass of a spherical silica filler with an average particle diameter of 12 μm as an inorganic filler. In Comparative Example 2, with relation to the surface roughness of the surface 18S, the ten-point average roughness (Rzjis) is 1.46 μm, the average space between the asperities 19 (RSm) is 49 μm, the skewness (Rsk) is −0.25, and the average thickness is 5 μm (10 μm before drying). Used in Comparative Example 2 are 46.5 parts by mass of a base material and 2.4 parts by mass of Irgacure (registered trademark) TPO, with no filer contained. Examples 1 to 11 and Comparative Example 1 were manufactured by the manufacturing method described prior to the description of the comparative experiment, whereas Comparative Example 2 was partially differently manufactured. According to the manufacturing method of Comparative Example 2, after the coating material production step, the application step, and the drying step that are same as those of the manufacturing method of Examples 1 to 11 and Comparative Example 1, the surface 18S of the pen-input surface material 18 in Example 6 is stuck to the dried coating material to transfer the shape of the surface 18S (transfer step). In a curing step after the transfer step, the coating material is irradiated with an ultraviolet ray such that a peak illumination is 200 mV/cm² and an integrated irradiation dose is 800 mJ/cm². Other conditions in the curing step of the manufacturing method of Comparative Example 2 are the same as those in the curing step of the manufacturing method of Examples 1 to 11 and Comparative Example 1. After the curing step, the pen-input surface material 18 in Example 6 is separated (separation step). As described above, the surface 18S of the pen-input surface material 18 in Comparative Example 2 is formed by transferring the surface 18S of the pen-input surface material 18 in Example 6, and thus Comparative Example 2 includes no filler.

In Comparative Example 3, with relation to the surface roughness of the surface 18S, the ten-point average roughness (Rzjis) is 2.98 μm, the average space between the asperities 19 (RSm) is 621 μm, the skewness (Rsk) is 1.23, and the average thickness is 6 μm (12 μm before drying). Used in Comparative Example 3 are 44.6 parts by mass of a base material, 2.3 parts by mass of Irgacure (registered trademark) 184 as a photopolymerization initiator, and 2 parts by mass of an amorphous silica filler as an inorganic filler with an average particle diameter of 5 μm. In Comparative Example 4, with relation to the surface roughness of the surface 18S, the ten-point average roughness (Rzjis) is 0.74 μm, the average space between the asperities 19 (RSm) is 28 μm, the skewness (Rsk) is 0.91, and the average thickness is 5 μm (10 μm before drying). Used in Comparative Example 4 are 39.9 parts by mass of a base material, 2.1 parts by mass of Irgacure (registered trademark) 184 as a photopolymerization initiator, and 3.5 parts by mass of an acrylic filler as an organic filler with an average particle diameter of 1.6 μm and a refractive index of 1.495, and 3.5 parts by mass of a styrene-acrylic filler as an organic filler with an average particle diameter of 1.4 μm and a refractive index of 1.545. In Comparative Example 5, with relation to the surface roughness of the surface 18S, the ten-point average roughness (Rzjis) is 0.08 μm, the average space between the asperities 19 (RSm) is 205 μm, the skewness (Rsk) is 0.73, and the average thickness is 10 μm (20 μm before drying). Used in Comparative Example 5 are 44.6 parts by mass of a base material, 2.3 parts by mass of Irgacure (registered trademark) 184 as a photopolymerization initiator, and 2 parts by mass of a styrene-acrylic filler as an organic filler with an average particle diameter of 6 μm and a refractive index of 1.525. Comparative Examples 3 to 5 were performed with the manufacturing method described prior to the description of the comparative experiment as in the case with Examples 1 to 11 and Comparative Example 1.

The results of the comparative experiment will be described. As illustrated in FIG. 5, in each of Comparative Examples 1, 2, 3, and 5, damage was observed on the surface 18S of the pen-input surface material 18, whereas in each of Examples 1 to 11 and Comparative Example 4, no damage was observed on the surface 18S of the pen-input surface material 18. In addition, in each of Comparative Examples 1, 3, and 5, no adherence of shavings was observed. In Comparative Example 1, the ten-point average roughness (Rzjis) has a largest value of 8.27 μm, the vertical gap between the asperities 19 on the surface 18S is largest. If the vertical gap between the asperities 19 on the surface 18S is excessively large, the touch pen P is excessively worn by the asperities 19, and the asperities 19 are not fully filled with the shavings and thus the surface having the asperities 19 is not sufficiently flattened. As a result, no adherence of the shavings was found, and the surface 18S is less likely to be damaged. In Comparative Example 2, only the skewness (Rsk) has a negative value (−0.25), and the proportion of the convex portions 19B is higher than the proportion of the concave portions 19A on the surface 18S. Accordingly, the touch pen P is contacted with the large number of convex portions 19B excessively so that the surface 18S is likely to be damaged. In Comparative Example 3, the average space between the asperities 19 (RSm) has a largest value of 621 μm, and thus the arrangement density of the asperities 19 is lowest. If the arrangement density of the asperities 19 is lowest, the touch pen P is not sufficiently worn by the asperities 19 and the surface having the asperities 19 is not sufficiently flattened with the shavings. As a result, no adherence of the shavings was found, and the surface 18S is likely to be damaged. In Comparative Example 5, the ten-point average roughness (Rzjis) has a smallest value of 0.08 μm, and thus the vertical gap between the asperities 19 on the surface 18S is smallest. If the vertical gap between the asperities 19 on the surface 18S is smallest, as in Comparative Example 3, the touch pen P is not sufficiently worn by the asperities 19, and the surface having the asperities 19 is not sufficiently flattened with the shavings. As a result, no adherence of the shavings was found, and the surface 18S is likely to be damaged.

In contrast, in each of Examples 1 to 11 and Comparative Example 4, the ten-point average roughness (Rzjis) had a value as moderately high as 6 μm or less and as moderately low as 0.1 μm or more, and the vertical gap between the asperities 19 is not excessively large or small. Accordingly, the touch pen P is properly worn and the surface having the asperities 19 is sufficiently flattened, thereby the surface 18S is less likely to be damaged. In Comparative Example 4, the surface 18S is less likely to be damaged, but shavings adhering to the surface 18S cannot be wiped off. In Comparative Example 4, the average space between the asperities 19 (RSm) has a smallest value of 28 μm that is smaller than 30 μm, and the arrangement density of the asperities 19 on the surface 18S is quite high. Accordingly, the shavings from the touch pen P enter the asperities 19 and it was difficult to remove the shavings. In contrast, in each of Examples 1 to 11, the average space between the asperities 19 (RSm) has a value as moderately high as 500 μm or less and as moderately low as 30 μm or more, and the arrangement density of the asperities 19 is not excessively high or low. Accordingly, the touch pen P is properly worn and the surface having the asperities 19 is sufficiently flattened, and the surface 18S is less likely to be damaged. In addition, if shavings from the touch pen P enter the asperities 19, the shavings can be easily wiped off. Further, in each of Examples 1 to 11, the skewness (Rsk) has a positive value, and thus the proportion of the concave portions 19A is higher than the proportion of the convex portions 19B included in the asperities 19. Accordingly, the touch pen P is less likely to be excessively contacted with the convex portions 19B, and as a result, the surface 18S is less likely to be damaged. In Comparative Example 4, the skewness (Rsk) has a positive value and the surface 18S is less likely to be damaged as in Examples 1 to 11.

Subsequently, Examples 1 to 11 will be compared. In Examples 3, 4, 7, and 9, the ten-point average roughness (Rzjis) has a relatively high value as compared to Examples 1, 2, 5, 6, 8, 10, and 11. This is possibly because an amorphous inorganic filler with irregular particle diameters is used in Examples 3, 4, 7, and 9, and a spherical organic filler with an uniform particle diameter is used in Examples 1, 2, 5, 6, 8, 10, and 11. That is, it is preferable to use an amorphous inorganic filler with irregular particle diameters to increase the value of the ten-point average roughness (Rzjis), and it is preferable to use a spherical organic filler with an uniform particle diameter to decrease the value of the ten-point average roughness (Rzjis). Comparing Examples 3 and 4 among Examples 3, 4, 7, and 9, a value of the average space between the asperities 19 (RSm) is relatively smaller in Example 4 than that in Example 3. This is possibly because the material and the average particle diameter of the filler are same in Examples 3 and 4 and the blend ratio of the filler is relatively higher in Example 4 than that in Example 3. In a comparison among Examples 2, 5, 6, and 10 in which two kinds of fillers different in material and average particle diameter are used, the similar tendency was found, and the value of the average space between the asperities 19 (RSm) is smaller as the blend ratio of the filler is higher. By adjusting the material, the blend ratio, and the average particle diameter of the filler properly, the surface roughness relating to the asperities 19 on the surface 18S can be controlled properly.

In Example 7, the ten-point average roughness (Rzjis) has a value of 5.28 μm that is within a range of 4 μm to 6 μm inclusive. On the other hand, in each of Examples 1 to 6 and 9 to 11, the ten-point average roughness (Rzjis) has a value that is within a range of 0.3 μm to 4 μm inclusive and the vertical gap between the asperities 19 on the surface 18S is preferable. Therefore, in Examples 1 to 6 and 9 to 11, the wearing of the touch pen P by the asperities 19 is favorably suppressed and the surface having the asperities is properly flattened with the shavings from the worn touch pen P, and the surface 18S is less likely to be damaged. In Example 8, the ten-point average roughness (Rzjis) has a value of 0.28 μm that is within a range of 0.1 μm to 0.3 μm inclusive. On the other hand, in each of Examples 1 to 6 and 9 to 11, the ten-point average roughness (Rzjis) has a value that is within a range of 0.3 μm to 4 μm inclusive, and the vertical gap between the asperities 19 is sufficiently ensured on the surface 18S. Therefore, in Examples 1 to 6 and 9 to 11, the touch pen P is properly worn by the asperities 19 and the surface having the asperities 19 is properly flattened with the shavings, and the surface 18S is less likely to be damaged. In Example 9, the average space between the asperities 19 (RSm) has a value of 432 μm that is within a range of 400 μm to 500 μm inclusive. On the other hand, in each of Examples 1 to 8 and 11, the average space between the asperities 19 (RSm) has a value that is within a range of 40 μm to 400 μm inclusive, and the arrangement density of the asperities 19 on the surface 18S is kept properly high. Therefore, in Examples 1 to 8 and 11, the touch pen P is sufficiently worn by the asperities 19 and the surface having the asperities 19 is sufficiently flattened with the shavings, and the surface 18S is less likely to be damaged. In Example 10, the average space between the asperities 19 (RSm) has a value of 38 μm that is within a range of 30 μm to 40 μm inclusive. On the other hand, in each of Examples 1 to 8 and 11, the average space between the asperities 19 (RSm) has a value that is within a range of 40 μm to 400 μm inclusive, and the arrangement density of the asperities 19 on the surface 18S is kept properly low. Therefore, in Examples 1 to 8 and 11, even if the shavings from the touch pen P enter the asperities, the shavings can be removed more easily.

In each of Examples 3, 4, and 9, the ten-point average roughness (Rzjis) has a value that is within a range of 2 μm to 4 μm inclusive. On the other hand, in each of Examples 1, 2, 5, 6, and 10, the ten-point average roughness (Rzjis) has a value that is within a range of 0.5 μm to 2 μm inclusive, and the vertical gap between the asperities 19 on the surface 18S is more preferable. Therefore, in Examples 1, 2, 5, 6, and 10, the wearing of the touch pen P by the asperities 19 is more favorably suppressed, and the surface having the asperities 19 is flattened more properly with the shavings from the worn touch pen P, and the surface 18S is further unlikely to be damaged. In Example 11, the ten-point average roughness (Rzjis) has a value of 0.45 μm that is within a range of 0.3 μm to 0.5 μm inclusive. On the other hand, in each of Examples 1, 2, 5, 6, and 10, the ten-point average roughness (Rzjis) has a value that is within a range of 0.5 μm to 2 μm inclusive, and the vertical gap between the asperities 19 on the surface 18S is more sufficiently ensured. Therefore, in Examples 1, 2, 5, 6, and 10, the touch pen P is more properly worn by the asperities 19 and the surface having the asperities 19 is more properly flattened with the shavings, and the surface 18S is further less likely to be damaged. In Example 3, the average space between the asperities 19 (RSm) has a value of 369 μm that is within a range of 300 μm to 400 μm inclusive. On the other hand, in each of Examples 1, 4 to 8, and 11, the average space between the asperities 19 (RSm) has a value that is within a range of 50 μm to 300 μm inclusive, and the arrangement density of the asperities 19 on the surface 18S is kept high more favorably. Therefore, in Examples 1, 4 to 8, and 11, the touch pen P is worn more favorably by the asperities 19 and the surface having the asperities 19 is flattened more favorably with the shavings, and the surface 18S is further less likely to be damaged. In Example 2, the average space between the asperities 19 (RSm) has a value of 48 μm that is within a range of 40 μm to 50 μm inclusive. On the other hand, in each of Examples 1, 4 to 8, and 11, the average space between the asperities 19 (RSm) has a value that is within a range of 50 μm to 300 μm inclusive, and the arrangement density of the asperities 19 on the surface 18S is kept low more favorably. Therefore, in Examples 1, 4 to 8, and 11, even if the shavings of the touch pen P enter the asperities 19, the shavings can be removed more easily.

As described above, the polarizing plate 12 of the present embodiment has the pen-input surface material 18, the polarizer 12A that selectively transmits light in a specific vibration direction, and the pair of base bodies 12B that sandwiches the polarizer 12A therebetween as described above. The pen-input surface material 18 is disposed to overlap the surface of either of the pair of base bodies 12B opposite to the polarizer 12A side. According to the thus configured polarizing plate 12, the surface 18S of the pen-input surface material 18 is less likely to be damaged and the light passing through the polarizer 12A is less likely to be scattered by the damage.

The liquid crystal display device (display device) 10 of the present embodiment includes the polarizing plate 12, the liquid crystal panel (display panel) 11 that is disposed to overlap the polarizing plate 12 opposite to the pen-input surface material 18 side to display images, and the touch panel pattern 16 that is integrally provided on the liquid crystal panel 11 to detect the position of input with the touch pen P. According to the thus configured liquid crystal display device 10, when an input is performed with the touch pen P based on the images displayed on the liquid crystal panel 11, the position of the input with the touch pen P can be detected by the touch panel pattern 16. The surface 18S of the pen-input surface material 18 included in the polarizing plate 12 is less likely to be damaged, and thus the liquid crystal display device 10 is excellent in outer appearance thereof and in visibility of the displayed images.

### OTHER EMBODIMENTS

The technology described herein is not limited to the embodiment described above and with reference to the drawings. The following embodiments may be included in the technical scope.

(1) In the foregoing embodiment, in Examples 1 to 11 of the comparative experiment, each skewness (Rsk) is a positive value. Alternatively, the value of the skewness (Rsk) may be zero. Besides, each value of the ten-point average roughness (Rzjis), the average space between the asperities (RSm), and the skewness (Rsk) may be different from the values in Examples 1 to 11. In such a case, the ten-point average roughness (Rzjis) is within a range of 0.1 μm to 6 μm inclusive, the average space between the asperities (RSm) is within a range of 30 μm to 500 μm inclusive, and the skewness (Rsk) is zero or higher.

(2) If the values are altered based on (1), it is preferable that the ten-point average roughness (Rzjis) is within a range of 0.3 μm to 4 μm inclusive and the average space between the asperities (RSm) is within a range of 40 μm to 400 μm inclusive. More preferably, the ten-point average roughness (Rzjis) is within a range of 0.5 μm to 2 μm inclusive and the average space between the asperities (RSm) is within a range of 50 μm to 300 μm inclusive.

(3) Besides the foregoing embodiment, the material, the blend amount, the blend ratio, the average particle diameter, the particle diameter distribution, and the refractive index of the filler can be changed as appropriate. Similarly, the materials and the blend ratios of the base material, the photopolymerization initiator, the thickener, the leveling agent, and the solvent can also be changed as appropriate.

(4) If the material for the base material is altered based on the above (3), ultraviolet curable resin materials other than pentaerythritol triacrylate can be used. In addition, light curable resins to be cured by light in wavelength ranges other than an ultraviolet ray can be used. Further, thermosetting resin materials can also be used as a material for the base material.

(5) In the foregoing embodiment, the numerical values of indexes for surface roughness relating to the asperities on the surface of the pen-input surface material are controlled by mainly adjusting the blend amount, the average particle diameter, the particle diameter distribution of the filler, and the film thickness of the pen-input surface material. Alternatively, the numerical values of indexes for surface roughness relating to the asperities on the surface of the pen-input surface material can be controlled without using a filler. In that case, in manufacturing the pen-input surface material, the indexes for surface roughness relating to the asperities on the surface of the pen-input surface material can be controlled as appropriate by using a plurality of kinds of synthetic resin materials and utilizing the phase separation phenomenon (spinodal decomposition) in the process of volatilization of the solvent due to differences in solubility and polarity among these synthetic resin materials.

(6) In the foregoing embodiment, polyacetal is used as an exemplary material for the touch pen. However, the specific material for the touch pen can be changed as appropriate.

(7) In the foregoing embodiment, in the comparative experiment, only Comparative Example 2 includes the transfer step and the separation step in the manufacturing method. Alternatively, the transfer step and the separation step may be included in the manufacturing method of Examples 1 to 11.

(8) In the foregoing embodiment, the touch panel pattern is a self-capacitance type. Alternatively, the touch panel pattern may be a mutual-capacitance type.

(9) In the foregoing embodiment, the touch panel pattern is provided only on the array substrate of the liquid crystal panel. Alternatively, the touch panel pattern may be provided on each of the array substrate and the CF substrate. Still alternatively, the touch panel pattern may be provided only on the CF substrate.

(10) In the foregoing embodiment, the pen-input surface material is provided on the polarizing plate. Alternatively, if the touch panel is an out-cell type in which a separately manufactured touch panel is externally attached to the liquid crystal panel, for example, the pen-input surface material can be provided on the touch panel.

(11) In the foregoing embodiment, the transmissive liquid crystal panel is taken as an example. Alternatively, a semi-transmissive liquid crystal panel or a reflective liquid crystal panel may be used. The reflective liquid crystal panel includes a polarizing plate that is provided on the front side of the liquid crystal panel and has the pen-input surface material, but does not include a polarizing plate and a backlight device on the back side of the liquid crystal panel.

(12) In the foregoing embodiment, the planar shape of the liquid crystal display device (the liquid crystal panel and the backlight device) is a vertically-long rectangle. Alternatively, the planar shape of the liquid crystal display device may be a horizontally-long rectangle, circle, semi-circle, long circle, oval, trapezoid, or the like.

(13) In the foregoing embodiment, the liquid crystal display device includes a liquid crystal panel as a display panel. Alternatively, the liquid crystal display device may be an organic EL display device using an organic EL panel as the display panel.

1. A pen-input surface material having a surface on which an input is to be performed with a pen,
wherein the pen-input surface material has ten-point average roughness (Rzjis) ranging from 0.1 μm to 6 μm inclusive, an average space between asperities (RSm) on the surface ranging from 30 μm to 500 μm inclusive, and skewness (Rsk) of zero or higher.

2. The pen-input surface material according to claim 1, wherein
the ten-point average roughness (Rzjis) on the surface is within a range of 0.3 μm to 4 μm inclusive, and
the average space between the asperities (RSm) on the surface is within a range of 40 μm to 400 μm inclusive.

3. The pen-input surface material according to claim 1, wherein
the ten-point average roughness (Rzjis) on the surface is within a range of 0.5 μm to 2 μm inclusive, and
the average space between the asperities (RSm) on the surface is within a range of 50 μm to 300 μm inclusive.

4. A polarizing plate comprising:
the pen-input surface material according to claim 1;
a polarizer that selectively transmits light in a specific vibration direction; and
a pair of base bodies that sandwiches the polarizer therebetween,
wherein the pen-input surface material is disposed to overlap a surface of one of the pair of base bodies opposite to a polarizer side.

5. A display device comprising:
the polarizing plate according to claim 4;
a display panel that is disposed to overlap the polarizing plate opposite to a pen-input surface material side and displays an image; and
a touch panel pattern that is integrally provided on the display panel to detect a position of input with the pen.
